(19) United States
(12) Patent Application Publication
(10) Pub. No.: US 2005/0021407 A1
(43) Pub. Date: Jan. 27, 2005

(54) Enhanced user display for use in a restaurant kitchen

(76) Inventor: James B. Kargman, Chicago, IL (US)

Correspondence Address: Howard E. Silverman;Greenberg Traurig, LLP, Suite 2500, 77 West Wacker Drive, Chicago, IL, 60601, US

(21) Appl. No.: 10/873,862

(22) Filed: Jun. 21, 2004

Related U.S. Application Data
(60) Provisional application No. 60/480,268, filed on Jun. 20, 2003.

(51) Int. Cl. G06F 17/60

(52) U.S. Cl. 705/15

(57) ABSTRACT

A graphical display for use with a pizza restaurant point of sale system display and includes a first display screen for display upon a monitor positioned at a make-line station which conveys to the kitchen staff one or more orders for pizza and displays a graphical representation of each pizza and photo-realistic image of each individual topping to be placed on the pizza prior to cooking and a second display screen for display upon a monitor positioned at a packing station which presents to the kitchen staff a photo realistic image of a cooked pizza corresponding to each displayed food order of the first display screen where the graphical display which provides for increased accuracy and efficiency in food preparation.

### BACKGROUND OF THE INVENTION

1. Field of the Invention

The present invention relates generally to the operation of a pizza restaurant, and in particular discloses a plurality of graphical displays for use in a restaurant kitchen environment. The graphical displays are preferably displayed to kitchen personnel working the “make-line” area in a kitchen where pizzas and other related food items are assembled and/or prepared before being placed into an oven for cooking. As used herein the term “make-line” refers in the context of a pizza restaurant to the area within a kitchen were a pizza crust is prepared and ingredient toppings are applied before the pizza is placed into a pizza oven for cooking.

2. Background Art

The presently disclosed graphical displays serve to assist the kitchen staff in properly preparing food orders and to otherwise enhance kitchen operations, performance and minimize mistakes. The various graphical displays disclosed in the present invention may be provided via a CRT or LCD display positioned in a kitchen so as to be viewable by at least the make-line personnel. The present system may also be used at the customer counter (the point of purchase) during the placement of an order and at the packing station (in the kitchen area) where a pizza is removed from the oven and placed in the carton or container for delivery to the customer.

One of the challenges in the food service industry is to fulfill a customer's food order accurately and efficiently. Food preparation stations in a kitchen control the overall appearance and quality of a food item and are a common source of errors in the food preparation often lead to customer dissatisfaction and/or waste. One way in which restaurants have attempted to assure product consistency and quality in food preparation is to place pictures on the wall of the kitchen illustrating what the food product should look like in various stages of preparation. For example, posted pictures may illustrate the uncooked food product prior to being placed into an oven as well as the finished product after being cooked. However, this method is feasible only for a small number of products, and is especially difficult, if not impossible to implement, in a pizza restaurant where a pizza product can be prepared in thousands of different combinations of sizes, crusts, cheeses, sauces, and topping distributions.

A manual or computerized order entry system for use in the pizza industry must permit the ordering of complex food items, where for example, a pizza may be ordered with any combination of 20 or more different ingredients, on either one-half or the entire pizza. Due to training, language difficulties, and a variety of other causes, occasional “mis-makes” occur—where for example the right ingredients are placed on the wrong half of the pizza, or the wrong ingredients are used. Accordingly, there is a need for a technology that can reduce the possibility of errors and assure product consistency.

The present invention, as will be shown, can be implemented to eliminate the difficulties presented by the conventional methods, and provides a means to assure that pizzas, and other foods that consist of multiple options, are prepared correctly and consistently.

Advances in systems technology have made it possible for a point-of-sale (POS) system (which typically handles order entry, cash register functions and kitchen printouts etc.) and also generate high resolution graphic images on demand. By combining this image generation capability with the existing ability of POS systems to present an accurate coded representation of a particular food order, it is possible to provide the kitchen with information displays indicating the correct sequence for the assembly of the ingredients which make up a particular pizza order.

Another advantage of the present invention, is the elimination of the language barrier. By generating and viewing a photorealistic image of the ingredients of an order, the kitchen staff preparing a food order can see the actual depiction of the order and execute the order without the need to read a particular language.

The present system generally includes one or more display monitors positioned in various places within the pizza restaurant. In the preferred embodiment of the invention, the monitors are placed at the kitchen make-line stations. Monitors may also be displayed at customer order stations and at the pizza packing station, as described herein.

The display monitors may comprise conventional CRT displays or more advanced LCD displays. Each of the monitors are connected to the computerized POS system operated by the restaurant. A typical POS system comprises at a minimum a central computer connected to a cash drawer, data entry terminal(s) and printers. One or more of the various components can be combined into a single device. For example a computerized register can include a cash drawer, a display screen, a computer keyboard, a printer and an integrated microprocessor and software for running the entire system.

A typical customer orders a pizza by phone or in person or even on-line. According to the preferred embodiment of the present invention, a customer who comes into a pizza restaurant steps up to a counter and orders one or more food items by speaking to an order taker. The food order can be a take-out order, or an order for consumption on premises. Once an order is taken, the order must be conveyed to the kitchen for preparation, cooking, packing and delivery.

### SUMMARY OF THE INVENTION

A graphical display for use with a point of sale system display operated in a pizza restaurant which provides for increased accuracy and efficiency in food preparation is disclosed. A primary user interface screen is provided for display upon a monitor positioned at a make-line station which interface conveys to the kitchen staff one or more orders for pizza. The interface includes a visual image of each pizza topping to be placed on the pizza ordered by the customer where such images are displayed arranged in the order upon which they are placed upon the pizza prior to cooking and where each image is accompanied by a textual identification of the topping and the portion of each to be applied. A companion user interface screen is provided for display upon a monitor positioned at a packing station which serves to convey to the kitchen staff a photo realistic image of a cooked pizza corresponding to each displayed food order of the first display screen.

The graphical user interface display includes a primary user interface for display upon a monitor positioned at a make-line station which display conveys to the kitchen staff visual information of one or more orders for pizza. In one embodiment the graphical display interface comprises one or more order regions for separately displaying each food item comprising an order and one or more ingredient icons representing each ingredient to be combined to form the pizza as ordered wherein said ingredient icons are visually arranged so as to indicated to a cook the order in which the ingredients are to be applied to form the pizza. Textual indicia is associated with each of the one or more ingredient icons to indicate in human readable text the name of the ingredient associated with each ingredient icon and placement control icons are associated with each of the one or more ingredient icons which serve to visually indicate the placement of each ingredient upon the pizza. Portion control indicia are provided associated with each of the one or more ingredient icons which serve to visually indicate the weight of each ingredient to be applied to the pizza and portion control icons are associated with each of the one or more ingredient icons which serve to visually indicate generally the portion of each ingredient to be applied to the pizza. A crust icon is associated with each order for a pizza visually indicating the type of pizza crust ordered and crust indicia is associated with each order for a pizza visually indicating in human readable text the type of pizza crust ordered. Weight indicia is associated with each order for a pizza visually indicating in human readable text the total weight of the pizza ordered.

In one embodiment of the present invention the one or more of the ingredient icons comprise a photo-realistic image of a particular food ingredient. In a further embodiment the one or more ingredient icons may be accompanied by additional visual cues which serve to further convey information relative to the presence or absence of a particular ingredient. Such cues may take the form of bold faced image to signify an extra portion or an “x” to signify that no portion is to be applied.

The one or more order regions further include a comment region containing human readable text providing further comment relative to the preparation of the pizza and each order region possesses a background color which signifies a particular type of food item ordered so as to permit orders for pizza to be readily distinguished from orders for other food items. Multiple food items purchased within a single order are displayed in order regions displayed adjacent one another and each order region further includes an order field which displays in human readable text the association of one order to another. Each order region may include a delivery field which displays in human readable text an indication of whether the food item is to be delivered to a customer as well as a time field which displays in human readable text the an indication of how much time as passed since the order was placed.

The overall images are dynamically generated toward being displayed in a manner which provides for increased accuracy and efficiency in food preparation In one embodiment each ingredient icon is displayed in connection with a background color which serves to indicate the type of ingredient and portion control icons display the weight of each ingredient in a manner which provides that the weight of the pizza when prepared does not exceed the total weight as indicated by the weight indicia.

In the preferred embodiment graphical user interface display further includes a companion user interface for display upon a monitor positioned at a packing station which display conveys to the kitchen staff visual information of one or more orders for pizza, and wherein the companion user interface comprises one or more order regions for separately displaying each food item comprising an order, a photo-realistic image displayed within each of the one or more order regions presenting a visual image of the pizza ordered after being cooked. In addition textual indicia is displayed associated with the one or more images indicating in human readable text the name of each ingredient ordered and crust indicia is associated with each order for a pizza visually indicating in human readable text the type of pizza crust ordered.

In the companion user interface display multiple food items purchased within a single order are displayed in order regions displayed adjacent one another, each order region further includes an order field which displays in human readable text the association of one order to another and each order region further includes a delivery field which displays in human readable text an indication of whether the food item is to be delivered to a customer. Each order region further includes a time field which displays in human readable text the an indication of how much time as passed since the order was placed and each order region is displayed in connection with a background color which serves to indicate the type of food item ordered. Textual indicia is also associated with the one or more images are displayed in a manner which indicates the position upon the pizza to which each ingredient was to be placed.

### BRIEF DESCRIPTION OF THE DRAWINGS

FIG. 1 of the drawings is a primary display interface according to the preferred embodiment of the present invention wherein the display screen depicts three separate orders for a total of four food items;

FIG. 2 of the drawings illustrates an alternative embodiment of the primary display interface of the present invention configured to provide further information and/or visual queues to kitchen prep staff;

FIG. 3 of the drawings is a display screen according to the preferred embodiment of the present invention wherein the display screen of FIG. 1 is shown with annotations describing the various screen areas and their function;

FIG. 4 of the drawings illustrates a further display generated according to the present invention which conveys to the kitchen prep and packing staff the identity of each food item ordered displaying an enlarged visual image of the food item after being cooked;

FIG. 5 of the drawings illustrates LCD monitors which serve to present the user the unique displays according to the present invention;

FIG. 6 of the drawings illustrates another embodiment of the present invention wherein the display interface depicts a promotional or combination order is handled as a single order, which in the illustrated example, is a “quad” pizza is ordered which comprises four separate pizza's each individually configurable by the customer; and

FIG. 7 of the drawings illustrates the companion display interface which depicts the four pizzas when finished cooking.

### DETAILED DESCRIPTION OF THE DRAWINGS

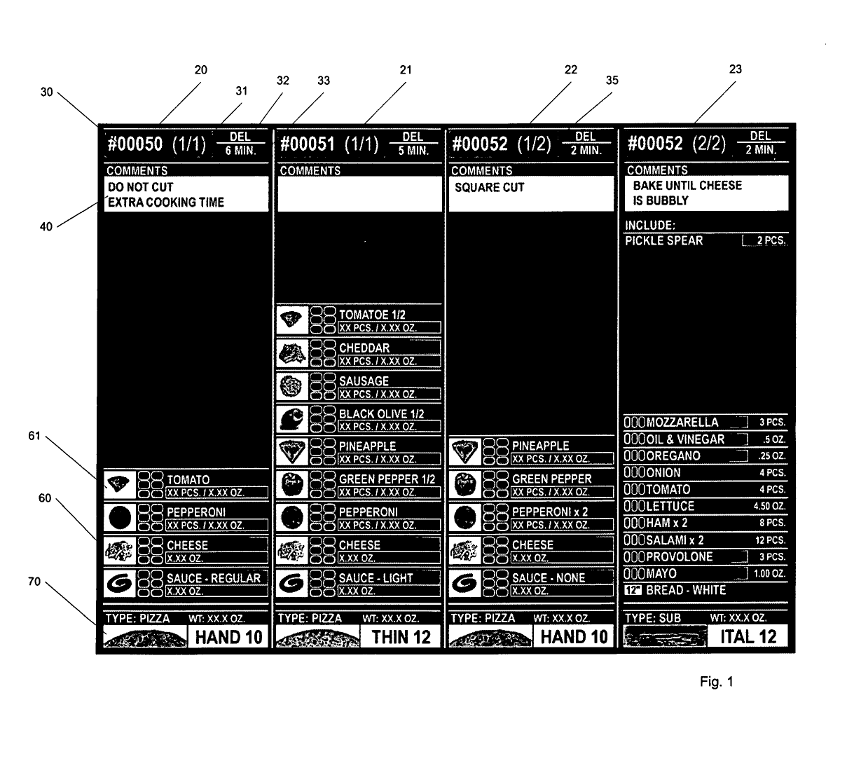

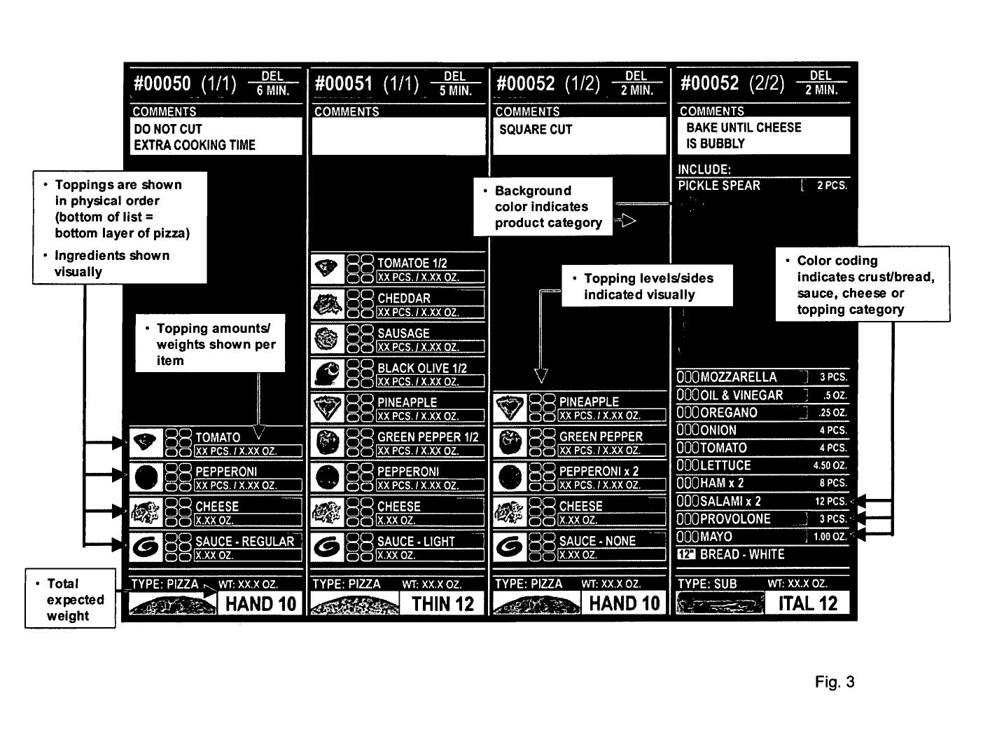

FIGS. 1 and 3 illustrate one embodiment of the present invention wherein the display depicts three separate orders 50, 51, and 52 for four different food items, each of which requires preparation in the kitchen. In the example of FIG. 1, three separate orders, orders number 50, 51 and 52 are illustrated. Order 50 illustrated in the left most column is an order for a single food item, in this case, a 10 inch hand-tossed pizza having regular portions of sauce, cheese, pepperoni and tomato applied uniformly over the entire surface of the pizza. Order 51 is for an 12 inch thin crust pizza having an assortment of ingredients some of which are to be applied uniformly over the entire surface and others of which are to applied only to one-half of the pizza. Order 52 is for two food items, specifically a 10 inch pizza and a 12 inch Italian submarine sandwich.

The graphical displays disclosed herein guide the cooks or kitchen prep-staff in a detailed manner towards properly preparing each food item to assure that the customer's order is accurately fulfilled and assure that the restaurant's standards are adhered to on a consistent basis. The present invention has particular utility in multi-location or franchised restaurants where consistency, customer satisfaction, quality and cost control are all very important.

Order 50 is illustrated in the first column 20. The top region of column 20 includes order field 30 wherein the specific order number assigned by the POS system followed by a parenthetical designation 31 indicating the number of unique food items which make up the particular order are displayed. Also shown in region 30 is an indication 32 designating that the order is for delivery and in indication 33 which indicates that 6 minutes have elapsed since the order was taken. This region of the display is further shown color coded to signal when an order has been pending for too long or otherwise needs special attention. As illustrated, a “new” or “recent” order is color coded “green” while an order which has been pending or “working” much longer is color coded “red”.

Comment field 40 is provided wherein specific customer comments can be included and conveyed to the kitchen prep-staff. In the example of order 50, the kitchen is instructed not to cut the pizza and to allow for extra cooking time. Field 60 is a region of the graphical display wherein the individual toppings which comprise the pizza are identified, namely, tomato, pepperoni, cheese and sauce being indicted. Toppings are shown in the physical order upon which they are to be applied to the pizza where the bottom-most listed ingredient comprises the bottom layer of the pizza applied immediately upon the crust. One novel aspect of the present invention is that iconic representations or photo realistic representations of the individual ingredients or toppings are displayed to assist the kitchen in preparing the food item. In example 61, a piece of tomato is illustrated. Further images include a piece of pepperoni, grated cheese and an icon resembling sauce. Each particular topping designation is conveyed to the prep staff using both a graphic symbol or photo realistic image together with a textual label. Moreover, as illustrated, a plurality of elliptical regions are provided in two columns with three rows each. The left and right columns correspond to the left and right sides of a pizza respectively whereas the rows provide a visual indication to the kitchen prep staff as to the quantity of each particular topping to be applied. In the first instance, the textual label identifies the particular ingredient as tomato. Immediately below is a designation indicating the approximate number of pieces and/or approximate weight of the particular ingredient to be weighed out and applied to the pizza as ordered by the customer.

Finally, at the lower portion of column 20 appears region 70 wherein the actual food item is identified in text, in the present example of order 50, it is a pizza. The overall total expected weight of the finished pizza, before cooking, is also provided. Immediately below that is shown a visual image of a portion of the crust of the particular pizza, in this case using a photo realistic image, followed by a short-hand indication of both the type of crust as well as the size of crust. In the example of order 50 the indication is that of a hand-tossed pizza, 10 inches in diameter.

Order 51 which appears in column 21 is similar with the exception that additional ingredients are shown as ordered by the customer. It can be readily seen that the first ingredient, tomato, is to be applied to the upper-most surface of the pizza and only on the right side of the pizza as designated both by the single colored elliptical circle appearing in the right column as well as the symbol “½” following the word “tomato”. A similar example as shown in connection with the ingredients black olive and green pepper where a single portion of the ingredient is indicated to be applied only to the left half of the pizza. Order 51 is for a food item is for a thin crust pizza, 12 inches diameter.

Order number 52 is designated as a two item order via the parenthetical indication set forth in region 30 and specifically at position 35. In particular, comments shown in this example indicate to the kitchen that the pizza is to be cut in squares as opposed to conventional triangular shapes. The ingredients shown comprise pineapple, green pepper, pepperoni and cheese. In the present example, the ingredient “sauce” is still shown inasmuch as it is typically always an ingredient on pizza, however, in this case no elliptical shapes are colored-in and the designation “none” is shown following the word “sauce” thereby indicating to the kitchen that no sauce is to be applied. Moreover, it is readily apparent that in the present example that the customer has ordered not a single, but rather a double portion of pepperoni as indicated graphically to the prep kitchen via the 2 rows of elliptical circles being colored-in and further by the designation “X2” following the word pepperoni.

One particularly novel application of the present graphical user interface is the ability to dynamically create each particular visual cooking instruction for each particular food item where instructions are dynamically generated and linked to a particular protocol established by the restaurant. For example, it may be determined that in no instance should a 12 inch pizza is ever to weigh more than 1 pound. Accordingly, adjustments are automatically made to the portion specified based upon the overall number of ingredients specified by the customer to be applied to the pizza. As illustrated in column 21, order 51 has quite a number of ingredients listed and accordingly the POS computer system provides for a dynamic adjustment of the piece count and/or weight count of each individual ingredient or topping such that the overall total weight of the product does not exceed the specified limitation. In short, portion controls and, in turn, cost controls are automatically implemented when instructing the kitchen at the time the pizza is being prepared.

Column 23 of the graphical user interface illustrated in FIG. 1 illustrates the second food item which makes up order number 52 which, in the present case, is an Italian submarine sandwich. This food item is identified by the field 70 wherein the type is referred to as “Sub” and a photo realistic image depicting a submarine sandwich. Moreover, the short-hand designation “Ital 12” signifies to the kitchen that an Italian submarine of 12 inches in length is to be prepared. As in the other instances comments are provided which indicate that the product is to be baked in the oven until the cheese is bubbling. Additional instructions are also set forth indicating 2 pieces of a pickle are to be provided to the customer. Again, the individual ingredient to be placed onto the sub prior to cooking are illustrated. In the illustrated example piece or weight counts are provided in graphical indication as well as in the form of colored elliptical regions which visually illustrate to the prep staff the quantity of a particular ingredient to be applied. In addition, textural indications such as in connection with the ingredient “ham” which is followed by the designation “X2” signify that a double portion of ham is to be included, which in the present case is 8 pieces of ham.

It should also be noted that the background color of column 23 is different from that of columns 20-22 which serve to indicate to the kitchen and particularly, the individual preparing the order, that indeed a different product category of food item is being ordered. In the illustrated example pizzas bear one particular background color while sandwiches bear another. It can further be noted in connection with column 23 that the ingredients themselves bear different color coded backgrounds which further indicate a category of the ingredient or topping. For example, cheese bears a particular background color while oil, vinegar, mayo and oregano bear another. Vegetable items, such as onion, tomato and lettuce are shown bearing a green background while meats, ham and salami, are shown having yet another background color. These visual clues supplement the textual indication of the order which is presented to kitchen staff such that a particular food item can be fulfilled quickly, efficiently and accurately by the kitchen and the individual cook preparing the order.

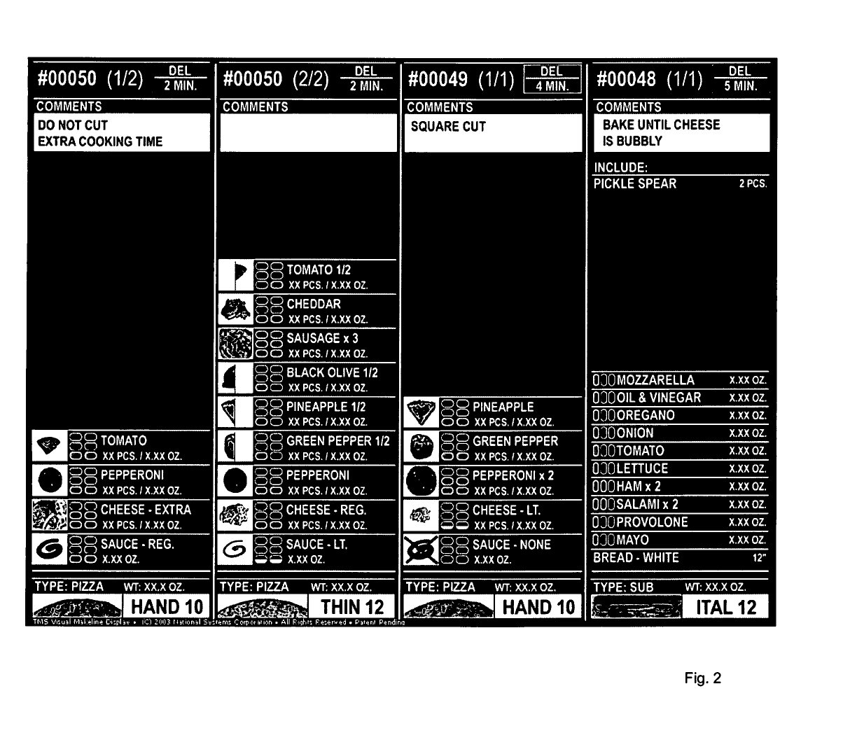

FIG. 2 of the drawings illustrates an alternative embodiment of the primary display interface of the present invention. While the display screen functions substantially the same, some differences exist which provide further information and/or visual queues to kitchen prep staff. For example, the visual images of the individual ingredients are displayed in various sizes depending upon the quantity of the topping to be applied to the pizza. A double portion of an ingredient is indicated by displaying an enlarged visual image of the ingredient, in addition to the use of colored ellipses and a textual message. The left-most column illustrates a pizza to which a double portion of cheese is to be applied, as indicated by the enlarged image of shredded cheese. The column associated with order number 49 illustrates a double portion of pepperoni, as indicated by the enlarged image of a slice of pepperoni. The column associated with item two of order 50 illustrates a pizza to which a light quantity of sauce is to be applied, as indicated by reduced sized icon and half-filled colored ellipses.

The application of an ingredient to only one-half of the pizza is further indicated by displaying only one-half of the visual image of the particular ingredient, as illustrated in connection with item two of order 50 where only a partial image of a black olive, pineapple slice, and green pepper are displayed. Only the left side image is displayed indicating that said ingredients are to be applied to the left half of the pizza. Similarly, only the right half of the tomato image is displayed indicating that the topping is to be applied only to the right half of the pizza. Additionally, order 49 is for a pizza which is to have no sauce. This non-standard ingredient is indicated by displaying the icon for sauce with an “x” marked through the image.

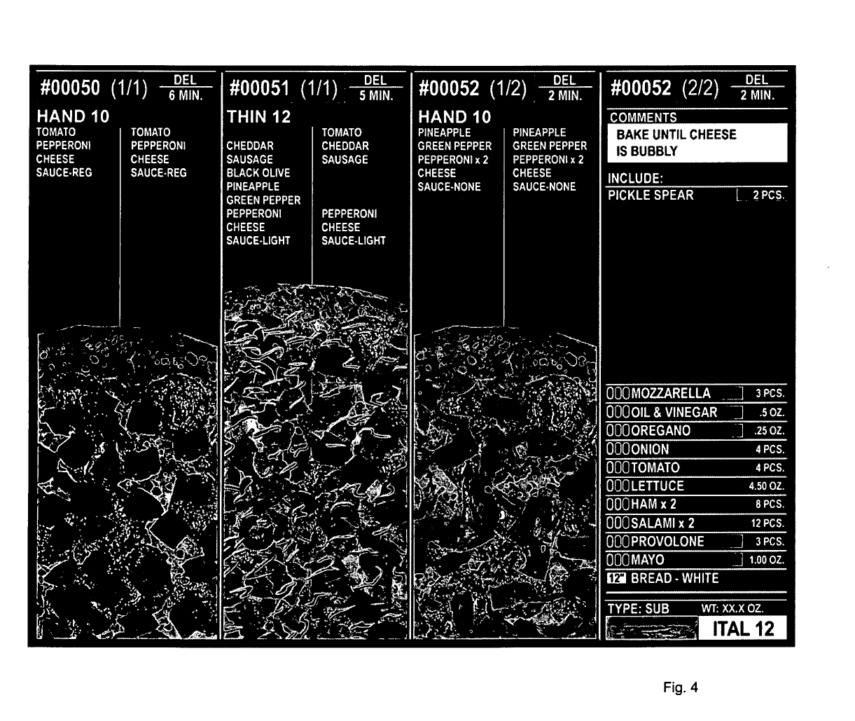

FIG. 4 of the drawings illustrates a further display generated according to the present invention. The particular graphical user interface generated in FIG. 4 is intended to convey to the kitchen and in particular both the prep staff and the packing staff the identity of each food item ordered in a slightly different fashion, including by displaying an enlarged visual image of the food item after being cooked. The various columns displayed in FIG. 4 correspond to the columns of FIG. 1. Each of the individual columns display a visual image of the particular pizzas with the specific toppings ordered. Column 20 illustrates a 10 inch hand-tossed pizza having identical ingredients on both sides of the pizza namely, tomato, pepperoni, cheese and sauce as indicated by the text appearing above the visual image of the finished pizza. The ingredients or toppings are again shown in the physical order in which they are applied to the pizza, with the bottom-most listed ingredient appearing as the bottom layer on the pizza. By viewing the visual image associated with order number 51 it can be easily detected that the pizza is one where the 2 halves are different.

The foregoing visual display facilitates the detection of mistakes and mis-makes and assures quality control and proper delivery of a pizza to a customer by offering the kitchen the ability to visually confirm that indeed the proper pizza has been prepared at the preparation stage and moreover that the proper pizza is being packed for delivery to the user at the packing stage following cooking. A delivery person and/or order packer is able to see that, for example, order 51 is for a pizza where the 2 halves are dramatically different. Should the packer attempt to place a pizza which more resembles that shown in column 21 into a box with order number 51, the error will be detected and a customer dissatisfaction issue avoided.

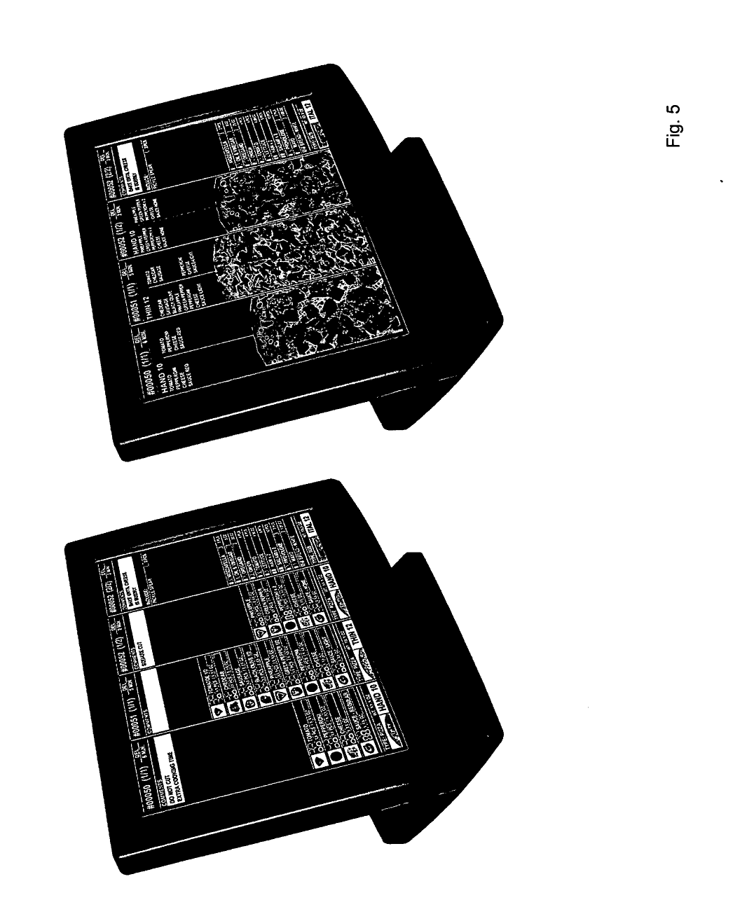

While the foregoing graphical user interface system has been described for its primary use in connection with “make-line” region within a kitchen, it certainly has utility in other areas of the restaurant. This particular display screen as shown in FIG. 4 may be made available and viewable to the customer at the order entry phase where such orders may be entered in person or even over a computer connectible remote order situation via website where a graphical confirmation of the particular order being placed by the consumer may be achieved. Examples of an LCD monitor providing the foregoing displays are illustrated in FIG. 5.

To avoid miscommunications between the customer and the order taker, and to further enhance the sales experience, a display monitor may also be positioned so as to be viewable by the customer during the order placement process. As the order taker enters the customer's order into the point of sale system, the computerized system generates a visual image on the display which presents the customer with a photo-realistic image of the food item(s) being ordered. If multiple pizzas are ordered, they can be displayed sequentially to the customer.

The same type of delivery screens may be placed at the packing station where the individual packers and/or the deliver drivers are thus able to confirm that indeed the proper pizza is being associated with the proper order and that the order is indeed correctly filled by the restaurant. Again, providing a photo realistic image of a particular pizza permits further quality control and consistency where, for example the relative position and a portioning of toppings and ingredients on a pizza.

Another embodiment of the present invention utilizes a further display monitor positioned at the packing station proximate the area in which pizzas are removed from the oven and placed in cartons or containers for delivery to the customer.

In a computerized point of sale system, an order ticket is typically prints bar coded labels which are applied to the cardboard carton frequently used to hold the finished pizza for delivery to the customer. The label may be applied to the carton immediately upon being printed or may be left loose at the packing station to be used only when a finished pizza is removed from the oven. In either event, the bar code label is scanned by the packer using a bar code reader connected to the point of sale system. (often to signal the point of sale system that the pizza has left the oven and is on its way to the customer.) When the bar code label is scanned, the system causes an image of the finished pizza to appear on the display monitor. The packer can thus visually recognize the pizza to be packed and visually verify they are indeed putting the correct pizza into the correct box or container. The display can further contain an overlay displaying an order number or customer name to further insure that the right customer is getting the right pizza.

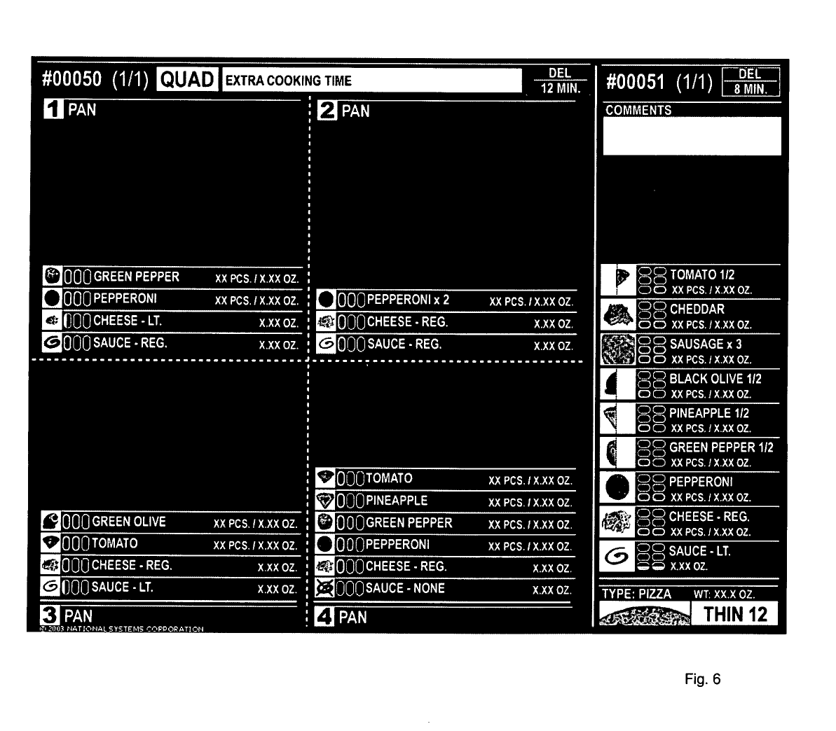

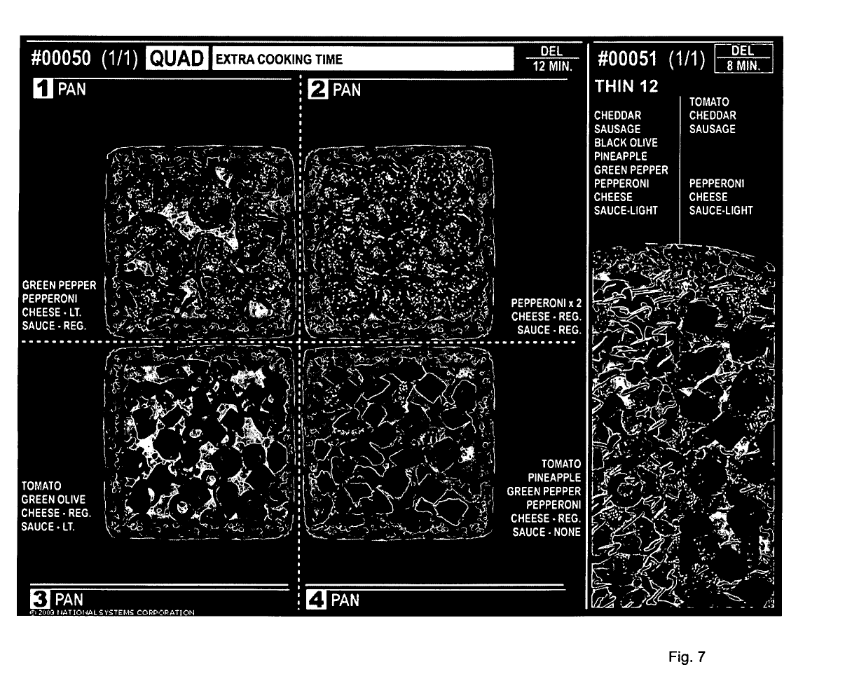

FIG. 6 of the drawings illustrates another embodiment of the present invention wherein a promotional or combination order is handled as a single order. In the illustrated example, a “quad” pizza is ordered which comprises four separate pizza's each individually configurable by the customer. The companion display illustrated in FIG. 7 depicts the four pizzas when finished cooking. The present invention may of course be adapted to handle and display other forms of promotions and offers which are best handled together.

The items which comprise an order need not be limited to food items. For example, a pizza delivery restaurant may offer a promotion to its customers which enable the customer to purchase or receive at no additional charge one of a limited number of DVD movies when they purchase a designated number or combination of food items as would be associated with a “dinner and a movie” promotion. A customer who takes advantage of the promotion would trigger an order which specifies the particular food items using one or more of the screen/column displays disclosed herein. However, an additional order screen/column will also be associated with that order to identify the DVD (or other promotional item) ordered by the customer.

The advent of high-speed DVD burner technology and high-speed internet access permits the restaurant to create the particular DVD movie ordered by the customer “on-demand” thereby avoiding the need to stock inventory and incur the risk of theft, damage and piracy and further permits strict audit control. The customer's order is entered into the store's POS system in the usual manner. Each food item and each DVD movie (or other promotional item) ordered is specified. The present invention includes a link between the POS system and a DVD/PC burner assembly which is connected via a high speed internet connection to an external data source which streams the DVD content to the store's burner toward creating the individual DVD movie ordered on an on-demand basis. The DVD movie is preferably of the type which self-destructs after a given number of viewings, though this need not necessarily be the case. Of course other multi-media content, such as CD audio, could be created on-demand as a promotion or premium offer. In addition, the data file used to burn the individual DVD's may be stored locally at the restaurant thereby omitting the need for the high-speed internet access.

While the kitchen prep staff is preparing the food order, the automated DVD burner is creating the DVD. The present display system will indicate to the kitchen staff, and in particular the staff charged with packing the food items for delivery, that a DVD, and indeed a particular DVD, is to be included with the order. The DVD creation equipment no only burns the content into the writeable portion of the DVD disc, it also automatically labels the disc. The DVD, and specifically the label, will accordingly appear on the visual display generated by the present invention to graphically inform the kitchen staff which DVD is to be delivered to the customer toward preventing mistakes in the same manner as with food items which are also prepared “to order” or “on-demand”.

The actual generation of the displayed images of a finished pizza can be accomplished through a variety of techniques and technologies. In a most direct fashion, a discrete photo-realistic image of a finished pizza is displayed. The system accordingly has in its electronic storage an inventory of images corresponding to each of the multitude of possible order combinations. Alternatively, a display layer technique can be employed where the graphical image is built up layer by layer. In such a system, transparent layers can be used to cause images layer to appear. Semi-transparent layers can also be used to add effect to the displayed image. In either case, the image of the finished pizza appears right before the customer's eyes.

While foregoing graphical user interface has been disclosed and discussed in the context of the pizza restaurant, the present invention may well be applied to other food preparation institutions and environments where consistency and quality control and cost control are of concern.

1. A graphical user display for use with a point of sale system display operated in a pizza restaurant which display provides for increased accuracy and efficiency in food preparation, the present graphical user display comprising:
a first user interface display for presentation upon a monitor positioned at a make-line station which display conveys to the kitchen staff one or more orders for pizza, and includes a visual image of each pizza topping to be placed on the pizza ordered by the customer where such images are displayed arranged in the order upon which they are to be placed upon the pizza prior to cooking and where each image is accompanied by a textual identification of the topping and the portion of each to be applied; and
a second user interface for presentation upon the monitor positioned at a packing station which display conveys to the kitchen staff a photo-realistic image of the cooked pizza corresponding to each displayed food order of the first user interface display.

2. A graphical display for use with a point of sale system operated in a pizza restaurant which display provides for increased accuracy and efficiency in food preparation, the graphical display including a primary user interface for presentation upon a monitor positioned at a make-line station which display conveys to the kitchen staff visual information of one or more orders for pizza, wherein the graphical display interface comprises:
one or more order regions for separately displaying each food item which forms a customer's order,
one or more ingredient icons representing each ingredient to be combined to form the pizza as ordered and wherein the ingredient icons are visually arranged so as to indicate the order in which the ingredients are to be applied to properly form the pizza;
textual indicia associated with each of the one or more ingredient icons serving to indicate in human readable text the name of the ingredient associated with each ingredient icon;
placement control icons associated with each of the one or more ingredient icons serving to visually indicate the placement of each ingredient upon the pizza;
portion control indicia associated with each of the one or more ingredient icons serving to visually indicate the weight of each ingredient to be applied to the pizza;
portion control icons associated with each of the one or more ingredient icons serving to visually indicate generally the portion of each ingredient to be applied to the pizza;
crust icon associated with each order for a pizza visually indicating the type of pizza crust ordered;
crust indicia associated with each order for a pizza visually indicating in human readable text the type of pizza crust ordered; and
weight indicia associated with each order for a pizza visually indicating in human readable text the total weight of the pizza as ordered.

3. The invention according to claim 2 wherein one or more of the ingredient icons comprises a photo-realistic image of a particular food ingredient.

4. The invention according to claim 3 wherein one or more ingredient icons are accompanied by an additional visual cue which serves to further convey information relative to the presence or absence of a particular ingredient.

5. The invention according to claim 2 wherein the one or more order regions further include a comment region for displaying human readable text serving to provide further information and instruction relative to the preparation of the pizza.

6. The invention according to claim 2 wherein each order region possesses a background color which signifies a particular type of food item ordered permitting orders for pizza to be readily distinguished from orders for other food items.

7. The invention according to claim 2 wherein multiple food items purchased within a single order are displayed in order regions adjacent one another.

8. The invention according to claim 7 wherein each order region further includes an order field which displays in human readable text the association of one order to another.

9. The invention according to claim 2 wherein each order region further includes a delivery field which displays in human readable text an indication of whether the food item is to be delivered to a customer.

10. The invention according to claim 2 wherein each order region further includes a time field which displays in human readable text an indication of how much time as passed since the order was placed.

11. The invention according to claim 2 wherein each ingredient icon is displayed in connection with a background color serving to indicate the type of ingredient.

12. The invention according to claim 2 wherein the portion control icon displays the weight of each ingredient to be applied such that the weight of the pizza when prepared does not exceed the total weight as indicated by the weight indicia.

13. The invention according to claim 2 wherein the graphical display further includes a companion user interface for presentation upon a monitor positioned at a packing station which display conveys to the kitchen staff visual information of one or more orders for pizza, and wherein the companion user interface comprises:
one or more order regions for separately displaying each food item comprising an order,
a photo-realistic image displayed within each of the one or more order regions presenting a visual image of at least a portion of the pizza as ordered after being cooked;
textual indicia associated with one or more photo-realistic images indicating in human readable text the name of each ingredient ordered; and
crust indicia associated with each order for a pizza visually indicating in human readable text the type of pizza crust ordered.

14. The invention according to claim 13 wherein multiple food items purchased within a single order are displayed in order regions adjacent one another.

15. The invention according to claim 13 wherein each order region further includes an order field which displays in human readable text the association of one order to another.

16. The invention according to claim 13 wherein each order region further includes a delivery field which displays in human readable text an indication of whether the food item is to be delivered to a customer.

17. The invention according to claim 13 wherein each order region further includes a time field which displays in human readable text an indication of how much time as passed since the order was placed.

18. The invention according to claim 13 wherein each order region is displayed in connection with a background color which serves to indicate the type of food item ordered.

19. The invention according to claim 13 wherein the textual indicia associated with the one or more images are displayed in a manner which indicates the relative position upon the pizza where each ingredient was to be placed.

20. A graphical user interface display for use with a point of sale system display operated in a pizza restaurant which display screen provides for increased accuracy and efficiency in food preparation, the graphical display including a primary user interface for display upon a monitor positioned at a make-line station which display conveys to the kitchen staff visual information of one or more orders for pizza, wherein the graphical display interface comprises:
one or more order regions dynamically generated for separately displaying each food item ordered, and
one or more ingredient icons representing each ingredient to be combined to form the pizza as ordered.

21. The invention according to claim 20 wherein said ingredient icons are visually arranged so as to indicated to a cook the order in which the ingredients are to be applied to form the pizza.

22. The invention according to claim 20 further including textual indicia associated with each of the one or more ingredient icons to indicate in human readable text the name of the ingredient associated with each ingredient icon.

23. The invention according to claim 20 further including placement control icons associated with each of the one or more ingredient icons which serve to visually indicate the placement of each ingredient upon the pizza.

24. The invention according to claim 20 further including portion control indicia associated with each of the one or more ingredient icons which serve to visually indicate the weight of each ingredient to be applied to the pizza.

25. The invention according to claim 20 further including portion control icons associated with each of the one or more ingredient icons which serve to visually indicate generally the portion of each ingredient to be applied to the pizza.

26. The invention according to claim 20 further including a crust icon associated with each order for a pizza visually indicating the type of pizza crust ordered.

27. The invention according to claim 20 further including crust indicia associated with each order for a pizza visually indicating in human readable text the type of pizza crust ordered.

28. The invention according to claim 20 further including weight indicia associated with each order for a pizza visually indicating in human readable text the total weight of the pizza ordered.

29. The invention according to claim 21 wherein one or more ingredient icons are photo-realistic images of a particular food ingredient.

30. A graphical display for use with a point of sale system display operated in a pizza restaurant which display screen provides for increased accuracy and efficiency in food preparation, the graphical display including a companion user interface for display upon a monitor positioned at a packing station which display conveys to the kitchen staff visual information of one or more orders for pizza, and wherein the companion user interface comprises:
one or more order regions for separately displaying each food item comprising an order,
a photo-realistic image displayed within each of the one or more order regions presenting a visual image of the pizza ordered after being cooked;
textual indicia associated with the one or more images indicating in human readable text the name of each ingredient ordered; and
crust indicia associated with each order for a pizza visually indicating in human readable text the type of pizza crust ordered.
